(19) United States
(12) Patent Application Publication
(10) Pub. No.: US 2025/0005483 A1
(43) Pub. Date: Jan. 2, 2025

(54) MARKOV CHAIN MODEL BASED ANALYSIS AND OPTIMIZATION OF INTELLIGENT DIGITAL WORKFLOWS

(71) Applicant: INTERNATIONAL BUSINESS MACHINES CORPORATION, Armonk, NY (US)

(72) Inventors: Jennifer M. HATFIELD, Portland, OR (US); Jeremy R. FOX, Georgetown, TX (US); Tushar AGRAWAL, West Fargo, ND (US); Sarbajit K. RAKSHIT, KOLKATA (IN)

(21) Appl. No.: 18/344,907

(22) Filed: Jun. 30, 2023

(51) Int. Cl. G06Q 10/0633

(52) U.S. Cl. CPC G06Q 10/0633

(57) ABSTRACT

A computer-implemented method includes detecting user interactions in a workflow via workflow user interfaces of user devices. The method further includes modeling the user interactions in the digital workflow based on the user interactions in a Markov chain model of the user interactions. The method further includes analyzing the Markov chain model of the user interactions with reference to performance goals of the digital workflow, to determine prospective modifications to the user interactions that would increase performance of the user interactions as indicated by the performance goals. The method further includes generating workflow modification recommendations based on the prospective modifications to the user interactions. The method further includes outputting the workflow modification recommendations to the user devices. The method further includes receiving a confirmation to select one of the workflow modification recommendations. The method further includes implementing a modification to the workflow based on the selected workflow modification recommendation.

### BACKGROUND

Aspects of the present invention relate generally to digital workflows and more specifically to optimizing digital workflows with computing devices.

Professional software workflows performed with computing devices are important in a variety of areas, including supply chain, operations, financial management, and human resource management, as examples. For various types of professional workflows, prompts or user interface (UI) elements are required for a user to interact with to accomplish tasks and make progress for the workflow. The workflows often change over time. UI technology, best practices, design philosophy, and applicable computing and communication devices also improve or evolve over time.

### SUMMARY

In a first aspect of the invention, there is a computer-implemented method including: detecting, by a processor set, user interactions in a digital workflow via one or more workflow user interfaces of one or more user devices. The method further includes modeling, by the processor set, the user interactions in the digital workflow based on the user interactions in a Markov chain model of the user interactions. The method further includes analyzing, by the processor set, the Markov chain model of the user interactions with reference to one or more performance goals of the digital workflow, to determine one or more prospective modifications to the user interactions that would increase performance of the user interactions as indicated by the one or more performance goals. The method further includes generating, by the processor set, one or more workflow modification recommendations based on the one or more prospective modifications to the user interactions. The method further includes outputting, by the processor set, the one or more workflow modification recommendations to at least one of the one or more user devices. The method further includes receiving, by the processor set, a confirmation to select one of the workflow modification recommendations. The method further includes implementing, by the processor set, a modification to the digital workflow based on the selected workflow modification recommendation.

In another aspect of the invention, there is a computer program product including one or more computer readable storage media having program instructions collectively stored on the one or more computer readable storage media. The program instructions are executable to detect user interactions in a digital workflow via one or more workflow user interfaces of one or more user devices. The program instructions are further executable to model the user interactions in the digital workflow based on the user interactions in a Markov chain model of the user interactions. The program instructions are further executable to analyze the Markov chain model of the user interactions with reference to one or more performance goals of the digital workflow, to determine one or more prospective modifications to the user interactions that would increase performance of the user interactions as indicated by the one or more performance goals. The program instructions are further executable to generate one or more workflow modification recommendations based on the one or more prospective modifications to the user interactions. The program instructions are further executable to output the one or more workflow modification recommendations to at least one of the one or more user devices. The program instructions are further executable to receive a confirmation to select one of the workflow modification recommendations. The program instructions are further executable to implement a modification to the digital workflow based on the selected workflow modification recommendation.

In another aspect of the invention, there is a system including a processor set, one or more computer readable storage media, and program instructions collectively stored on the one or more computer readable storage media. The program instructions are executable to detect user interactions in a digital workflow via one or more workflow user interfaces of one or more user devices. The program instructions are further executable to model the user interactions in the digital workflow based on the user interactions in a Markov chain model of the user interactions. The program instructions are further executable to analyze the Markov chain model of the user interactions with reference to one or more performance goals of the digital workflow, to determine one or more prospective modifications to the user interactions that would increase performance of the user interactions as indicated by the one or more performance goals. The program instructions are further executable to generate one or more workflow modification recommendations based on the one or more prospective modifications to the user interactions. The program instructions are further executable to output the one or more workflow modification recommendations to at least one of the one or more user devices. The program instructions are further executable to receive a confirmation to select one of the workflow modification recommendations. The program instructions are further executable to implement a modification to the digital workflow based on the selected workflow modification recommendation.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 depicts a flowchart of an exemplary method that a workflow optimizer code may perform in accordance with aspects of the present invention.

FIG. 5 depicts a simplified conceptual graph of a Markov chain model that a workflow optimizer code may generate in accordance with aspects of the present invention.

### DETAILED DESCRIPTION

Aspects of the present invention relate generally to optimizing professional software workflows and, more particularly, to applying a Markov chain based analysis and optimization to digital workflow user interaction patterns, including in applications in supply chain, operations, financial management, and human resource management, as examples. Digital workflow UI features may fall out of synchronization or otherwise become dissociated from other UI features. A user's habitual workflow interactions may become outdated, which may deter the user's efficient progression with an updated workflow. According to aspects of the invention, a computing system may track changes in a workflow and in factors that affect a workflow, such as changes in applicable UI technology and design, computing resources underlying the UI, and computing and communication devices applicable to the workflows, including newly available devices. In various embodiments, a computing system may also receive user preferences. In various embodiments, a computing system may perform a Markov chain based analysis and optimization of the workflow, and output optimization results in the form of recommendations to the user for changes in the user's workflow. The recommendations as outputted by the computing system may increase the user's efficiency in working through the workflow. The recommendations as outputted by the computing system may also be based in part on the user's preferences. In this manner, implementations of the invention may prompt users to update and optimize their workflow UI interactions with updated workflows.

Aspects of the present invention may use a combination of analytical modeling techniques based on both a Markov chain model and historical data to gain insights into the behavior and dynamics of user interaction with the digital workflow. By incorporating the principles of Markov chains, which capture the probabilistic transitions between different states of the system, a workflow optimizer code may construct a mathematical representation that enables it to optimize the future user interactions with the digital workflow. The workflow optimizer code may also complement Markov chain modeling with historical data of the user interactions with the digital workflow, which provide valuable empirical information about the past performance of the user interactions with the digital workflow. This combination may help ensure that the workflow optimizer code performs comprehensive analysis of the user interactions with the digital workflow, and may help enable the workflow optimizer code to enhance the accuracy and reliability of its optimizations of the workflow.

Various examples of this disclosure pertain to a method and system for analyzing and optimizing a workflow and user experience. The method and system may include monitoring and collecting real-time workflow interactions of a user to create a comparative analysis against historical data, using success thresholds established in terms of usage, response rates, performance, and speed, to identify performance lag areas where a user interaction occurs. The method and system may further include generating recommendations for how the user interaction can be optimized based on both preferences of the user and Markov chain process infused with user interactions and a skill set of the user for different contextual situations (e.g., specific locations or at different parts of the workflow). The method and system may optimize user interactions based on modalities or types of devices and types of displays. The method and system may enable multi-modal or multi-device interactions anywhere throughout the workflow. The method and system may enable and implement optimization and augmentation of the workflow based on the recommendations.

Implementations of the invention are necessarily rooted in computer technology. For example, the steps involved in collecting and statistically analyzing all user interactions of arbitrarily large numbers of personnel working their way through various aspects of a digital workflow, and processing and generating Markov chain based analyses and optimizations based thereon, are computer-based and cannot be performed in the human mind. Processing and generating Markov chain based analyses and optimizations including based on using a machine learning model are performed by a computer and cannot practically be performed in the human mind (or with pen and paper) due to the complexity and massive amounts of calculations involved. Processing and generating Markov chain based analyses and optimizations may typically involve immense volumes of calculations based on very large volumes of data in forming Markov chain based models and generating optimization outputs in real-time (or near real-time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, workflow data of personnel interacting with computing devices in a digital workflow process), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as workflow optimizer code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

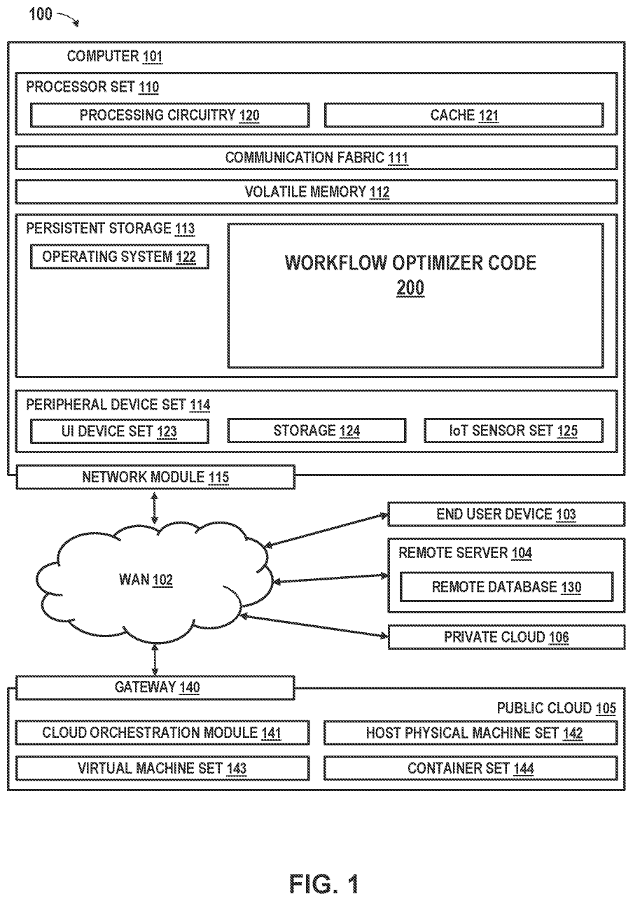

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

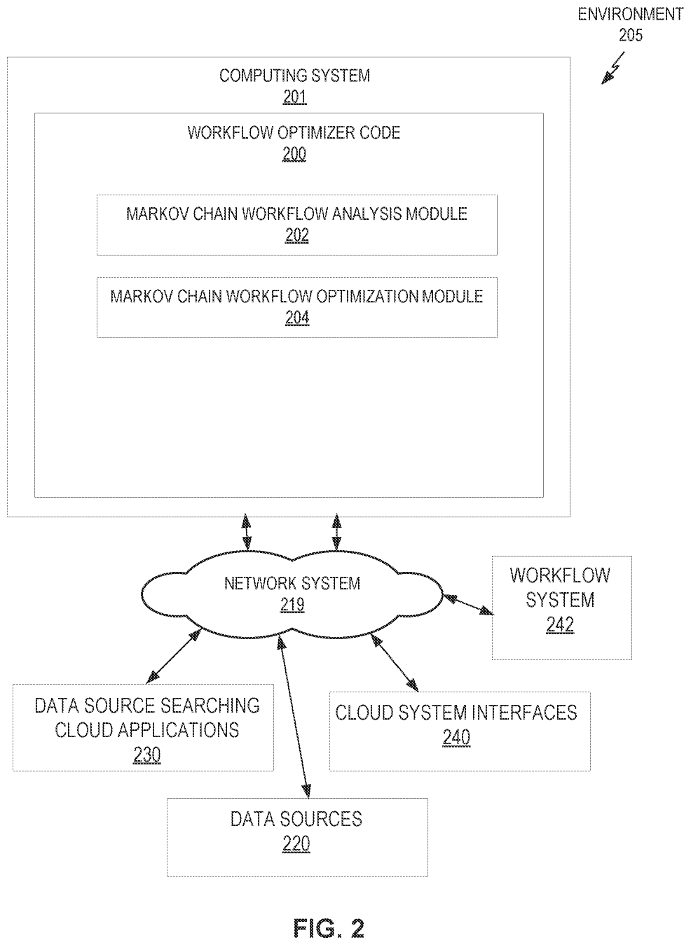

FIG. 2 shows a block diagram of an exemplary environment 205 in accordance with aspects of the invention. In embodiments, the environment includes computing system 201, which implements example Markov chain workflow analysis and optimizer code 200 (“workflow optimizer code 200”), as introduced above with reference to FIG. 1. In various embodiments, workflow optimizer code 200 of FIG. 2 comprises Markov chain workflow analysis module 202 and Markov chain workflow optimization module 204. Each of modules 202 and 204 may comprise modules of the code of block 200 of FIG. 1.

Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. Workflow optimizer code 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, environment 205 may include additional devices and/or networks; fewer devices and/or networks; different devices and/or networks; or differently arranged devices and/or networks than illustrated in FIG. 2.

Computing environment 205 also includes network system 219, data sources 220, data source searching cloud applications 230, cloud system interfaces 240, and workflow system 242. Workflow system 242 may comprise the actual professional application workflow system that the subject users work with on a day-to-day basis and which workflow optimizer code 200 may modify and implement optimizations for as a result of performing the analysis and optimization methods described herein. Workflow system 242 may comprise workflow system applications in supply chain, operations, financial management, and human resource management, as examples, or any other professional realm which may benefit from digital transformation. In some examples, workflow optimizer code 200 may be deployed to the cloud as a cloud application, may be configured to use data source searching cloud applications 230 to search arbitrarily large and widespread data sources 220 including user devices involved in digital workflows, and to interface with and perform functions described in this disclosure with an arbitrarily large and widespread number of workflow systems 242, and may be provided and accessible to arbitrarily large numbers of users around the world as a cloud-hosted software application via cloud system interfaces 240.

Computing system 201 may be implemented in a variety of configurations for implementing, storing, running, and/or embodying workflow optimizer code 200. Computing system 201 may comprise one or more instances of computer 101 of FIG. 1, in various examples. Data source searching cloud applications 230 and cloud system interfaces 240 may comprise or be comprised in one or more instances of computer 101, remote server 104, private cloud 106, and public cloud 105 of FIG. 1, in various examples. Workflow optimizer code 200, data source searching cloud applications 230, and cloud system interfaces 240 may be separate, as shown in FIG. 2, in various examples, in which workflow optimizer code 200 functions cooperatively with data source searching cloud applications 230 and cloud system interfaces 240. In various other examples, data source searching cloud applications 230 and cloud system interfaces 240 may be comprised as part of workflow optimizer code 200.

Network system 219 may comprise one or more instances of WAN 102, remote server 104, private cloud 106, and public cloud 105 of FIG. 1, in various examples. Computing system 201 in various examples may comprise a cloud-deployed computing configuration, comprising processing devices, memory devices, and data storage devices dispersed across data centers of a regional or global cloud computing system, with various levels of networking connections, such that any or all of the data, code, and functions of workflow optimizer code 200 may be distributed across this cloud computing environment. Workflow optimizer code 200, computing system 201, and/or environment 205 may thus collectively constitute, comprise, and/or be considered a workflow analysis and optimizer system, and may comprise and/or be constituted of one or more software systems, a combined hardware and software system, one or more hardware systems, components, or devices, one or more methods or processes, or other forms or embodiments.

In other examples, computing system 201 may comprise a single laptop computer, or a specialized statistical analysis workstation equipped with one or more graphics processing units (GPUs) and/or other specialized processing elements, or a collection of computers networked together in a local area network (LAN), or one or more server farms or data centers below the level of cloud deployment, or any of a wide variety of computing and processing system configurations, any of which may implement, store, run, and/or embody workflow optimizer code 200. Workflow optimizer code 200 may interact via network system 219 with any other proximate or network-connected computing systems to collect and/or process subject data from data sources 230, in various examples.

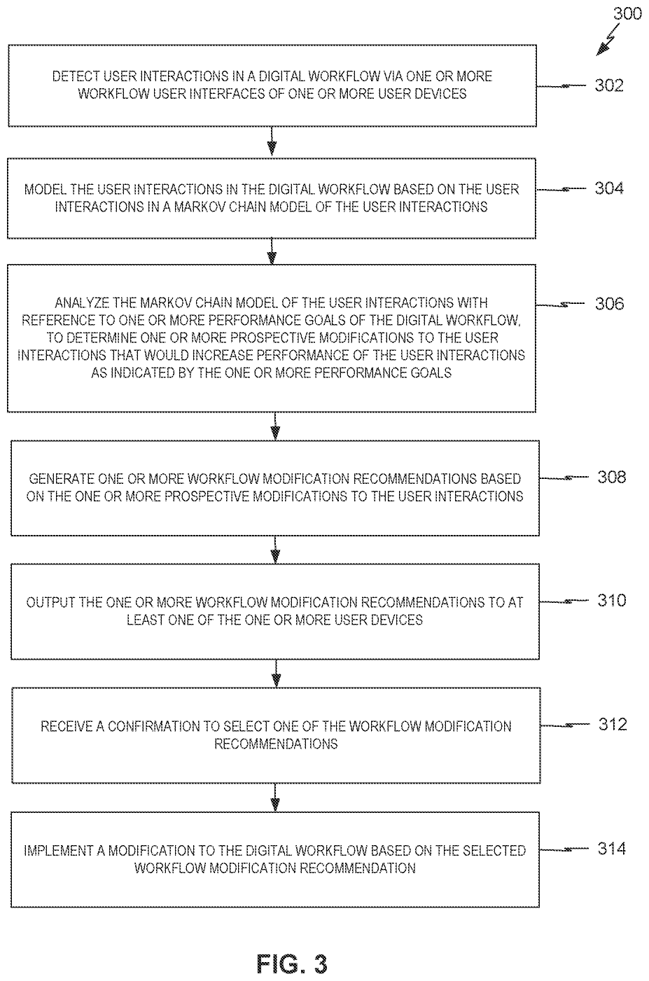

FIG. 3 shows a flowchart of an exemplary method 300 in accordance with aspects of the present invention. Steps of the method may be carried out in the environment of FIG. 2 and are described with reference to elements depicted in FIG. 2. In method 300, workflow optimizer code 200 (e.g., Markov chain workflow analysis module 202 thereof as shown in FIG. 2) detects user interactions in a digital workflow via one or more workflow user interfaces of one or more user devices (302). In various embodiments, and as described with respect to FIG. 2, workflow optimizer code 200 (e.g., Markov chain workflow analysis module 202 thereof) models the user interactions in the digital workflow in a Markov chain model of the user interactions (304). Workflow optimizer code 200 (e.g., Markov chain workflow analysis module 202 thereof) analyzes the Markov chain model of the user interactions with reference to one or more performance goals of the digital workflow, to determine one or more prospective modifications to the user interactions that would increase performance of the user interactions as indicated by the one or more performance goals (306). Workflow optimizer code 200 (e.g., Markov chain workflow optimization module 204 thereof) generates one or more workflow modification recommendations based on the one or more prospective modifications to the user interactions (308). Workflow optimizer code 200 (e.g., Markov chain workflow optimization module 204 thereof) outputs the one or more workflow modification recommendations to at least one of the one or more user devices (310). Workflow optimizer code 200 (e.g., Markov chain workflow optimization module 204 thereof) receives a confirmation to select one of the workflow modification recommendations (312). Workflow optimizer code 200 (e.g., Markov chain workflow optimization module 204 thereof) implements a modification to the digital workflow based on the selected workflow modification recommendation (314).

In an illustrative example, workflow optimizer code 200 detects an updated state for a particular user that the user has a new smart watch registered to the user's account associated with the digital workflow. Workflow optimizer code 200 adds to the Markov chain model for the user's workflow to incorporate workflow states enabled by the smart watch. Over time, workflow optimizer code 200 analyzes and determines, using the Markov chain model of the user's behavior in the digital workflow, that the user's responses to notifications from teammates in a collaboration messaging platform in the digital workflow are done exclusively with the user's desktop computer, and with a probability distribution of response time with a mean average response time of three hours. Workflow optimizer code 200 determines using the Markov chain model of the user's behavior in the digital workflow that the user has intervals of time away from the user's desktop computer, and that the user may be able to respond to teammate messages more quickly using the smart watch, which may improve and optimize the user's interactions in the digital workflow, based on speed of response time to teammates in the collaboration messaging platform being a performance criterion to optimize, and based on determining that enabling the collaboration messaging platform on the user's smart watch would not contradict any other performance criterion (in an example of 306). Workflow optimizer code 200 generates and outputs a recommendation output to the user, via one or more of the user's devices, such that the recommendation output may be available on the user's desktop and laptop computers and smartphone and smart watch (until responded to on any one of those user devices), to select to enable notifications from the collaboration messaging platform on the smart watch (in an example of 308 and 310). Workflow optimizer code 200 receives a user input affirming the recommendation (in an example of 312). Workflow optimizer code 200 then, in response to receiving the user input affirming the recommendation, modifies workflow system 242 to enable the notifications from the collaboration messaging platform on the user's smart watch (in an example of 314).

Workflow optimizer code 200 may thus analyze and optimize an intelligent workflow. In an illustrative example, analyzing and optimizing a workflow may include workflow optimizer code 200 identifying and generating recommendations for more efficient gesture UI inputs in a gesture-based project workflow. As another example, analyzing and optimizing a workflow may include workflow optimizer code 200 identifying a new or newly applicable device (e.g., a mobile device, wearable device, augmented reality/extended reality device, or other computing or communications device) that is accessible or assignable to a user or that the user possesses, and incorporating one or more workflow functions into the new device. Such one or more workflow functions to be newly incorporated into a new device may include notifications, alerts, user tasks, or any other outputs or user inputs for an intelligent digital workflow process, in various examples. Workflow optimizer code 200 may thus route notifications to the user's smartphone and/or smart watch or other smart wearable device instead of to the user's desktop or laptop computer. In ways such as these, workflow optimizer code 200 may provide a user experience of the workflow that is seamless, up-to-date, and optimized with reference to both the workflow and the indicated user preferences.

Workflow optimizer code 200 may generate optimization of skill-based recommendations based on iteratively generating candidate workflow modifications, analyzing testing responsiveness from the user, and determining how to improve on an earlier candidate workflow modification to generate a new candidate workflow modification. For example, this may include workflow optimizer code 200 changing timing of different tasks, and how the workflow system presents data and activities to the user. As a more specific example, this may include workflow optimizer code 200 selecting a workflow instruction set that the workflow system had outputted to the user's laptop computer, and instead, outputting a subsequent iteration of that instruction set to the user's smartphone, and outputting a subsequent iteration of that instruction set to the user's smart watch. Such a workflow instruction set may be a set of instructions from the workflow system for a workflow task, or a notification or message from another user engaged in the workflow with the workflow system, for example.

Workflow optimizer code 200 may then assess and compare one or more of the user's response time, performance accuracy, or one or more other performance criteria, in the user's responses to the instruction set when delivered to the user's smartphone and smart watch, against the prior performance baseline of delivery to the user's laptop computer. In an example, workflow optimizer code 200 may assess and determine that the user's response time is fastest when workflow optimizer code 200 outputs that instruction set of the workflow to the user's smart watch, with no loss in the user's accuracy of responses or other performance criteria. Workflow optimizer code 200 may then output instructions to the workflow system to revise the workflow such that the workflow system switches going forward to a default of outputting that that type of instruction set to the user's smart watch instead of to the user's laptop.

The above is one example of a number of workflow tasks or steps that workflow optimizer code 200 may analyze and optimize. Workflow optimizer code 200 may analyze and optimize numbers of such workflow tasks or steps in combination, using probability and statistical analysis, to iteratively model an optimized event sequencing over time, through an applied Markov chain model. Workflow optimizer code 200 may model each user's unique skill set and perform skill-based monitoring for past, present, and future feedback iterative looping. These are examples of workflow optimizer code 200 iteratively modeling the user interactions in the digital workflow based on the user interactions in the Markov chain model of the user interactions over time, wherein the generating the one or more workflow modification recommendations is further based on determined modifications in user skills over time based on the iteratively modeled Markov chain model.

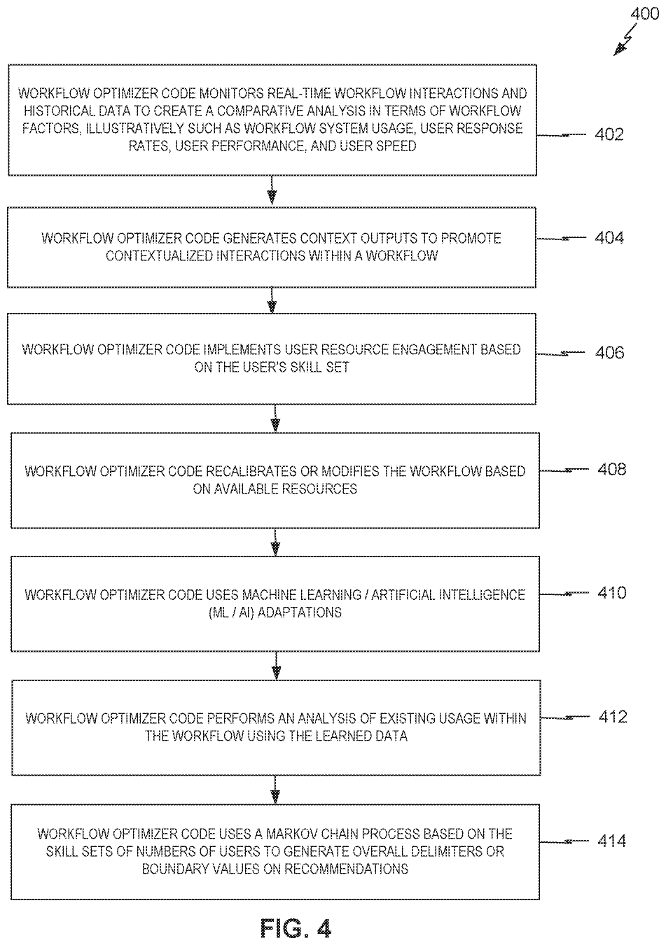

FIG. 4 depicts a flowchart of an example method 400 that workflow optimizer code 200 may perform in accordance with aspects of the present invention. The aspects in this and all methods depicted and described herein are not necessarily in a chronological order as shown, and may be done in overlapping times or in various orders.

Workflow optimizer code 200 may monitor real-time workflow interactions and historical data to create a comparative analysis in terms of workflow factors, illustratively such as workflow system usage, user response rates, user performance, and user speed (402). Workflow optimizer code 200 may represent each state or aspect of state of the digital workflow as a node in a Markov chain model, and each possible transition between states of the digital workflow due to each discrete user interaction as a connection or edge between the two states, e.g., the state prior to the user interaction and the state subsequent to the user interaction. Workflow optimizer code 200 may iteratively analyze the user interactions in the digital workflow over time and determine properties such as a probability and speed of the user interactions transitioning from one state to another state of the digital workflow, and reflect those properties in the connections between state nodes in the Markov chain diagram. Workflow optimizer code 200 may then use this analysis to identify areas where user interaction performance lags or where user interaction is less efficient than it could be, and generate recommendations for new user interactions to improve or optimize those user interactions. Workflow optimizer code 200 may thereby encourage creating a seamless, frictionless, and optimized interaction of the user with the workflow system and the digital workflow process. Workflow optimizer code 200 may thus model the user interactions in the digital workflow based on the user interactions in a Markov chain model of the user interactions, in this example, as in FIG. 3 at 304. These are also examples of workflow optimizer code 200 iteratively modeling the user interactions in the digital workflow based on the user interactions in the Markov chain model of the user interactions over time, wherein the generating the one or more workflow modification recommendations is further based on determined modifications in user skills over time based on the iteratively modeled Markov chain model.

Workflow optimizer code 200 may generate context outputs to promote contextualized interactions within a workflow (404). Workflow optimizer code 200 may enable optimization of the workflow UI and/or the workflow user experience (UX), which may incorporate, at least in part, the user's inputted preferences for how to interact in each contextual situation, e.g., in each location and part of the digital workflow process. Workflow optimizer code 200 may also enable multi-modal interactions, such as interactions across multiple devices (e.g., routing some notifications or instructions to the user's smartphone or smart watch instead of laptop), to help better optimize aspects of the workflow. This may be relevant for all types of digital workflow processes including digital workflow processes that are automated with efficient or minimal user interaction. This is thus an example of workflow optimizer code 200 building and analyzing the Markov chain model of the user interactions with reference to one or more performance goals of the digital workflow process, to determine one or more prospective modifications to the user interactions that would increase performance of the user interactions as indicated by the one or more performance goals, as in FIG. 3 at 306.

Workflow optimizer code 200 may implement user resource engagement based on the user's skill set (406). Workflow optimizer code 200 may assess a user's skill set and abilities to engage in various tasks, and based on those user skills and abilities, predict and match the user with specific operations in an activity or task of the workflow. Based on the outcome of the prediction and matching, including factors such as the user's indicated preferences, timing of interactions, and the requirements of the digital workflow process, workflow optimizer code 200 may augment or modify aspects of the UI or the UX of the digital workflow process, in ways that may optimize the user's progression through the digital workflow. This is thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306.

Additionally, workflow optimizer code 200 may recalibrate or modify the workflow based on available resources (e.g., computing resources) (408). Workflow optimizer code 200 may recommend new thresholds for optimal inputs and outputs, task completion times, and levels of engagement and interaction of the user with the workflow system to optimize the digital workflow process. This is thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306.

To further enhance its capabilities, workflow optimizer code 200 may use machine learning/artificial intelligence (ML/AI) adaptations (410). Workflow optimizer code 200 may continuously learn from user interactions and the data collected, including inputs from smartphones and/or smart watches or other smart wearables, to iteratively build a knowledge corpus of the user interactions with the workflow over time for analysis and optimization. This continuous learning process may help ensure that workflow optimizer code 200 evolves and undergoes continuous pressure testing for speed, reliability, and automation effectiveness. This is thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306. These are also examples of workflow optimizer code 200 iteratively modeling the user interactions in the digital workflow based on the user interactions in the Markov chain model of the user interactions over time, wherein the generating the one or more workflow modification recommendations is further based on determined modifications in user skills over time based on the iteratively modeled Markov chain model.

Workflow optimizer code 200 may further perform an analysis of existing usage within the workflow using the learned data (412). This analysis may enable workflow optimizer code 200 to predict modifications for optimize usage by the user, increase satisfaction for the user in working through the workflow, and long-term durability factors. This is thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306.

Further, workflow optimizer code 200 may employ a Markov chain process based on the skill sets of numbers of users to generate overall delimiters or boundary values on recommendations (414). Workflow optimizer code 200 may iteratively use this event-based sequencing over time as a baseline for a forecasting and prediction model. Combining skill-based analyses across many users into a single Markov chain digital workflow analysis may help enable workflow optimizer code 200 in providing valuable recommendations for prospective modifications of the workflow. This is thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306. This is also an example of workflow optimizer code 200 iteratively modeling the user interactions in the digital workflow based on the user interactions in the Markov chain model of the user interactions over time, wherein the generating the one or more workflow modification recommendations is further based on determined modifications in user skills over time based on the iteratively modeled Markov chain model.

Workflow optimizer code 200 may modify user guidance UI elements of a workflow UI level of guidance on how to perform the workflow inversely based on the user's experience in terms of the user's history of user interactions or the user's skill set. Workflow optimizer code 200 may identify workflow elements where the user interactions are faster than expected based on prior Markov chain modeling, and workflow optimizer code 200 may update the Markov chain model for the user interactions and skills et and decrease the amount of UI element guidance for the workflow and correspondingly increase the streamlining and speed of the workflow and the UI elements for the workflow. This may include workflow optimizer code 200 reducing manual steps in the workflow, or applying conditions or defaults in steps of the workflow based on the user's consistent past user interactions, or automating parts of the workflow, for example. Workflow optimizer code 200 may reduce or streamline UI elements of the digital workflow based on extending beyond Markov modeling and based on the history of the user's interactions indicative of user skills. Workflow optimizer code 200 may also port or transfer such updates to the skill set of a particular user and apply analogous optimization updates to workflow UI elements for other users with analogous skill sets. Workflow optimizer code 200 may thus generate one or more workflow modification recommendations based on the one or more prospective modifications to the user interactions, and generate a recommendation to reduce or remove one or more user interface elements based on user interactions that are faster than expected based on prior Markov chain modeling. Workflow optimizer code 200 may thus also identify other users with a skill set analogous to a given user, and, for the given user, generating one or more workflow modification recommendations is further based on one or more user interactions of the other users with a skill set analogous to the given user. These are thus examples of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306, and generating one or more workflow modification recommendations based on the one or more prospective modifications to the user interactions, as in FIG. 3 at 308.

Workflow optimizer code 200 may incorporate user skills as elements in a Markov chain model of the digital workflow process. Workflow optimizer code 200, based on the Markov chain model of the user interactions, may use past recorded task-based actual results and planned results, considering the observed skill sets and provided user data, such as for a given user referred to as John Doe. By analyzing repetition and observed usages, workflow optimizer code 200 may iteratively reorganize and improve the intelligent workflow by tailoring the workflow to ongoing updates workflow optimizer code 200 detects, beyond the initially observed baseline for the user, to the skill set, capabilities, and usage tendencies of each unique individual. As John evolves in his capabilities with the workflow, workflow optimizer code 200 may further modify and optimize the workflow by dynamically adjusting John's task assignments within the workflow. These are thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306. This is also an example of workflow optimizer code 200 modeling a user skill set based on the user interactions, wherein the modeling further comprises modeling the user interactions in the digital workflow and the user skill set based on the user interactions in the Markov chain model.

Further, workflow optimizer code 200, based on the Markov chain model of the user interactions, may dynamically adjust the workflow to meet the specific requirements of different users, such as Jane Doc. Workflow optimizer code 200 may customize the workflow based on different users' individual needs and preferences. These are thus another example of workflow optimizer code 200 building and analyzing the Markov chain model of the user interactions with reference to one or more performance goals of the digital workflow, to determine one or more prospective modifications to the user interactions that would increase performance of the user interactions as indicated by the one or more performance goals, as in FIG. 3 at 306. This is also an example of workflow optimizer code 200 modeling a user skill set based on the user interactions, wherein the modeling further comprises modeling the user interactions in the digital workflow and the user skill set based on the user interactions in the Markov chain model.

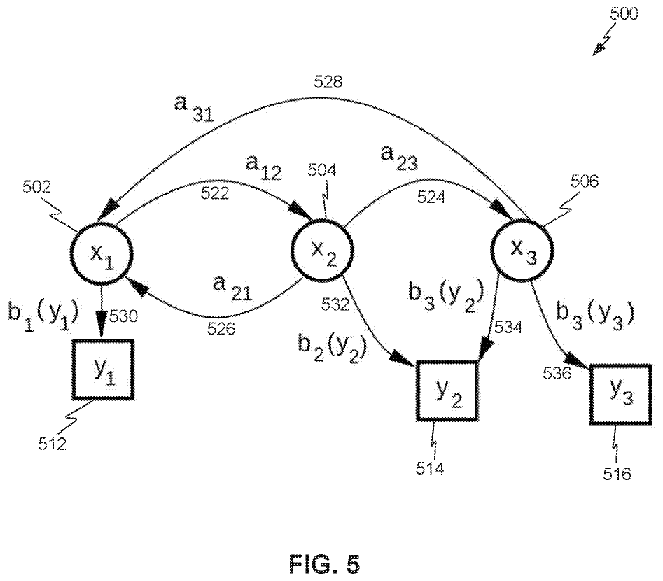

FIG. 5 depicts a simplified conceptual graph of a Markov chain model 500 that workflow optimizer code 200 may generate in accordance with aspects of the present invention. Markov chain model 500 includes working workflow states 502, 504, and 506, workflow outcomes 512, 514, and 516, and transition probabilities 522, 524, 526, 528, 530, 532, 534, 536 (which are also labeled with Markov chain model subscripted reference labels) for transitioning from one state to another. This is a simplified depiction, and a complete working Markov chain model that workflow optimizer code 200 may generate based on a complete actual digital workflow of users in a given application may contain tens, hundreds, thousands, or any arbitrary number of digital workflow states and transitions.

FIG. 5 conceptually depicts a simplified conceptual graph of a Markov chain model 500 of an example of how workflow optimizer code 200 may use an existing workflow within a Markov chain process and the extended, iterative observation of the user skill set to modify and optimize the workflow, in accordance with aspects of the present invention. Markov chain model 500 includes intermediate states (circular nodes with superscripted x) of the digital workflow, resulting end states (square nodes with superscripted y) of the digital workflow, and the transitions between the states in the digital workflow due to the user interactions in the digital workflow, along with the probabilities of transitions between the states. The aspects depicted and the aspects described below are not necessarily in a particular chronological order, and may be done in overlapping times or in various orders. The Markov chain model 500 as depicted in FIG. 5 is a simplified conceptual depiction, and an actual digital workflow is likely to be modeled in a Markov chain model with many more digital workflow states and transitions among states, relative to this simplified depiction. Workflow optimizer code 200 may thus model the user interactions in the digital workflow based on the user interactions in a Markov chain model of the user interactions, as in FIG. 3 at 304.

Workflow optimizer code 200 may actively monitor real-time workflow interactions, enabling effective workflow monitoring. Workflow optimizer code 200 may continuously analyze historical usage data, comparing the historical usage data against real-time data to identify variances in usage, timing, response rates, and other factors. This may help enable workflow optimizer code 200 to perform a comprehensive analysis of workflow patterns. Workflow optimizer code 200 may perform user interaction analysis by reviewing how numbers of users engage with the workflow system, setting success thresholds based on speed, quality, and accuracy. This analysis may help workflow optimizer code 200 optimize user interactions for a particular user with the workflow system.

Workflow optimizer code 200 may match the speed of user interactions with established benchmarks, such as minimum optimum speed required and average speed performing, which may help workflow optimizer code 200 ensure optimal workflow performance. Workflow optimizer code 200 may provide predictions and recommendations to enhance and speed up user engagement and interaction. Workflow optimizer code 200 may base these recommendations on an in-depth analysis of the user's responsiveness and other usage indicia. Workflow optimizer code 200 may also match users with specific operations within workflow activities or tasks, considering their skill set and ability to engage and interact with the workflow. This matching may help workflow optimizer code 200 ensure efficient allocation of resources in accomplishing the goals of the workflow, as well as help optimize productivity for the user.

Workflow optimizer code 200 may augment or modify aspects of the workflow UI or UX based on user preferences, timing of interactions, and the requirements of the digital workflow process. This may help workflow optimizer code 200 create a personalized and optimized user experience. Workflow optimizer code 200 may conduct comprehensive optimization analysis, considering various aspects of the system and workflow operations, as well as user engagement factors. This analysis may help workflow optimizer code 200 optimize the overall digital workflow process. Workflow optimizer code 200 may monitor task completions, levels of engagement, and input/output into the process, generating threshold alerts when deviations occur.

Workflow optimizer code 200 may perform recalibration of thresholds when deviations occur from the predefined thresholds. In such cases, an AI model of workflow optimizer code 200 may predict new thresholds for review by an administrator. Workflow optimizer code 200 may enable the infusion of the Markov process flow by using its ability to collect various skills and human user inputs. This may help workflow optimizer code 200 enable skill-based processing within the workflow. Workflow optimizer code 200 may reference workflow skills of other users from various potentially available resources and engage multiple inputs within the Markov chain model. This reference workflow skills of other users into the Markov chain modeling process for a given user may help workflow optimizer code 200 generate various types of workflow modifications to help optimize the given user's work in the workflow.

Workflow optimizer code 200 may generate optimization recommendations based on the analysis and responsiveness of the user. Workflow optimizer code 200 may seek to use these recommendations to help create an optimized and seamless and frictionless interaction for the user working through the workflow. These recommendations may include changes in the timing of tasks, and modifications in how the workflow system outputs data and work activity UI elements to one or more of the user's devices, for example.

Workflow optimizer code 200 may collect data feeds from user interactions, the workflow, and the system into a centralized or distributed data store. Workflow optimizer code 200 may use this steadily accumulating learning corpus to continuously help workflow optimizer code 200 to learn and improve its recommendations over time. Workflow optimizer code 200 may analyze usage patterns within the collected data corpus. Identifying usage patterns may help enable workflow optimizer code 200 to iteratively generate improved optimization recommendations over time, which may help to increase satisfaction of the user, and help ensure long-term value durability of the digital workflow process optimization recommendations that workflow optimizer code 200 generates. These are further examples of workflow optimizer code 200 iteratively modeling the user interactions in the digital workflow based on the user interactions in the Markov chain model of the user interactions over time, wherein the generating the one or more workflow modification recommendations is further based on determined modifications in user skills over time based on the iteratively modeled Markov chain model.

Workflow optimizer code 200 may initiate a Markov chain model 500 of the user's workflow to analyze and generate recommended workflow changes to help optimize the user's work interactions in performing the workflow, in accordance with aspects of the present invention. Workflow optimizer code 200 may define a software class for a Markov chain model 500 based on software classes for a user, a user skill set, past results, and planned results. Then, for a particular known user with a known skill set, or with an existing file of past results in the software class for past results, workflow optimizer code 200 may set a Markov chain model 500 for the particular known user based on the existing file of past results. Otherwise, for a new user without an existing user file, or for a known user with an existing user file but without a file for a known skill set, workflow optimizer code 200 may set a Markov chain model 500 for the user based on the planned results.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
detecting, by a processor set, user interactions in a digital workflow via one or more workflow user interfaces of one or more user devices;
modeling, by the processor set, the user interactions in the digital workflow based on the user interactions in a Markov chain model of the user interactions;
analyzing, by the processor set, the Markov chain model of the user interactions with reference to one or more performance goals of the digital workflow, to determine one or more prospective modifications to the user interactions that would increase performance of the user interactions as indicated by the one or more performance goals;
generating, by the processor set, one or more workflow modification recommendations based on the one or more prospective modifications to the user interactions;
outputting, by the processor set, the one or more workflow modification recommendations to at least one of the one or more user devices;
receiving, by the processor set, a confirmation to select one of the workflow modification recommendations; and
implementing, by the processor set, a modification to the digital workflow based on the selected workflow modification recommendation.

2. The computer-implemented method of claim 1, further comprising modeling a user skill set based on the user interactions,
wherein the modeling further comprises modeling the user interactions in the digital workflow and the user skill set based on the user interactions in the Markov chain model.

3. The computer-implemented method of claim 1, wherein the generating the one or more workflow modification recommendations based on the one or more prospective modifications to the user interactions comprises generating a recommendation for a modification of user interface elements of one of the one or more workflow user interfaces.

4. The computer-implemented method of claim 1, further comprising detecting a newly applicable user device,
wherein analyzing the Markov chain model of the user interactions with reference to one or more performance goals of the digital workflow comprises updating the Markov chain model with the newly applicable user device.

5. The computer-implemented method of claim 4, wherein the determining the one or more prospective modifications to the user interactions and generating the one or more workflow modification recommendations comprise generating a recommendation for using the newly applicable user device for one or more selected elements of the digital workflow.

6. The computer-implemented method of claim 5, wherein the one or more selected elements of the digital workflow for using the newly applicable user device for comprises notifications.

7. The computer-implemented method of claim 4, wherein the newly applicable user device comprises a smartphone.

8. The computer-implemented method of claim 4, wherein the newly applicable user device comprises a smart watch.

9. The computer-implemented method of claim 1, further comprising iteratively modeling the user interactions in the digital workflow based on the user interactions in the Markov chain model of the user interactions over time,
wherein the generating the one or more workflow modification recommendations is further based on determined modifications in user skills over time based on the iteratively modeled Markov chain model.

10. The computer-implemented method of claim 1, wherein the generating the one or more workflow modification recommendations is further based on user preferences indicated by a user input via at least one of the one or more user devices.

11. The computer-implemented method of claim 1, wherein generating the one or more workflow modification recommendations based on the one or more prospective modifications to the user interactions further comprises generating a recommendation to reduce or remove one or more user interface elements based on one or more user interactions of the user interactions that are faster than expected based on prior Markov chain modeling.

12. The computer-implemented method of claim 1, further comprising identifying other users with a skill set analogous to a given user,
wherein, for the given user, generating the one or more workflow modification recommendations is further based on one or more user interactions of the other users with a skill set analogous to the given user.

13. The computer-implemented method of claim 1, further comprising:
defining a software class for a Markov chain model based on software classes for a user, a user skill set, past results, and planned results;
for a known user with an existing file of past results in the software class for past results, setting the Markov chain model for the particular user based on the existing file of past results; and
for a new user without an existing user file or without a file for a known skill set, setting the Markov chain model for the user based on the existing file of planned results.

14. A computer program product comprising one or more computer readable storage media having program instructions collectively stored on the one or more computer readable storage media, the program instructions executable to:
detect user interactions in a digital workflow via one or more workflow user interfaces of one or more user devices;
model the user interactions in the digital workflow based on the user interactions in a Markov chain model of the user interactions;
analyze the Markov chain model of the user interactions with reference to one or more performance goals of the digital workflow, to determine one or more prospective modifications to the user interactions that would increase performance of the user interactions as indicated by the one or more performance goals;
generate one or more workflow modification recommendations based on the one or more prospective modifications to the user interactions;
output the one or more workflow modification recommendations to at least one of the one or more user devices;
receive a confirmation to select one of the workflow modification recommendations; and
implement a modification to the digital workflow based on the selected workflow modification recommendation.

15. The computer program product of claim 14, wherein the program instructions are further executable to model a user skill set based on the user interactions,
wherein the modeling further comprises modeling the user interactions in the digital workflow and the user skill set based on the user interactions in the Markov chain model.

16. The computer program product of claim 14, wherein the program instructions to generate the one or more workflow modification recommendations based on the one or more prospective modifications to the user interactions comprise program instructions to generate a recommendation for a modification of user interface elements of one of the one or more workflow user interfaces.

17. The computer program product of claim 14, further comprising program instructions to detect a newly applicable user device,
wherein the program instructions to analyze the Markov chain model of the user interactions with reference to one or more performance goals of the digital workflow comprise program instructions to update the Markov chain model with the newly applicable user device,
wherein the program instructions to determine the one or more prospective modifications to the user interactions and generate the one or more workflow modification recommendations comprise program instructions to generate a recommendation for using the newly applicable user device for one or more selected elements of the digital workflow.

18. A system comprising:
a processor set, one or more computer readable storage media, and program instructions collectively stored on the one or more computer readable storage media, the program instructions executable to:
detect user interactions in a digital workflow via one or more workflow user interfaces of one or more user devices;
model the user interactions in the digital workflow based on the user interactions in a Markov chain model of the user interactions;
analyze the Markov chain model of the user interactions with reference to one or more performance goals of the digital workflow, to determine one or more prospective modifications to the user interactions that would increase performance of the user interactions as indicated by the one or more performance goals;
generate one or more workflow modification recommendations based on the one or more prospective modifications to the user interactions;
output the one or more workflow modification recommendations to at least one of the one or more user devices;
receive a confirmation to select one of the workflow modification recommendations; and
implement a modification to the digital workflow based on the selected workflow modification recommendation.

19. The system of claim 18, wherein the program instructions to generate the one or more workflow modification recommendations based on the one or more prospective modifications to the user interactions comprise program instructions to generate a recommendation for a modification of user interface elements of one of the one or more workflow user interfaces.

20. The system of claim 18, further comprising program instructions to detect a newly applicable user device,
wherein the program instructions to analyze the Markov chain model of the user interactions with reference to one or more performance goals of the digital workflow comprise program instructions to update the Markov chain model with the newly applicable user device,
wherein the program instructions to determine the one or more prospective modifications to the user interactions and generate the one or more workflow modification recommendations comprise the program instructions to generate a recommendation for using the newly applicable user device for one or more selected elements of the digital workflow.
